(19) United States
(12) Patent Application Publication
(10) Pub. No.: US 2008/0110181 A1
(43) Pub. Date: May 15, 2008

(54) RESIDUAL BOIL-OFF GAS RECOVERY FROM LNG STORAGE TANKS AT OR NEAR ATMOSPHERIC PRESSURE

(75) Inventor: Judd Werner, Park City, UT (US)

Correspondence Address: CHEVRON CORPORATION, P.O. BOX 6006, SAN RAMON, CA, 94583-0806, US

(73) Assignee: CHEVRON U.S.A. INC., San Ramon, CA (US)

(21) Appl. No.: 11/558,379

(22) Filed: Nov. 9, 2006

(51) Int. Cl. F17C 7/04; F17C 3/10

(52) U.S. Cl. 62/48.1; 62/48.2

(57) ABSTRACT

A process is provided for recovering residual boil-off gas from LNG storage tanks at or near atmospheric pressure. Vaporized natural gas is recycled to an eductor to provide a motive force to withdraw residual boil-off gas in a container. The vapor is mixed with intermediate pressure LNG and sent to a vaporizer for down stream processing.

### FIELD OF THE INVENTION

The present invention relates to a method for recovering boil-off gas generated during vaporization of LNG.

### BACKGROUND OF THE INVENTION

Natural gas is a valuable, environmentally-friendly energy source. With gradually decreasing quantities of clean easily-refined crude oil, natural gas has become accepted as an alternative energy source. Natural gas may be recovered form natural gas reservoirs or as associated gas from a crude oil reservoir. Indeed, natural gas for use in the present process may be recovered from any process which generates light hydrocarbon gases.

The present invention relates to processing liquefied natural gas (LNG). Natural gas which is produced locally can be transported to market either by pipeline or by a mobile carrier, such as by truck, ship, barge and the like. Natural gas which is recovered from a remote location cannot be easily and inexpensively transported in the vapor phase, and is generally altered in some way, either chemically, or by liquefaction or pressurization, or a combination of these processes, prior to transportation. During liquefaction, the vapor-phase natural gas is cooled, often with one or more pressurization/flash depressurization cycles until the natural gas condenses. It is the liquefied natural gas which is transported from the remote site to the market site. Liquefied natural gas is desirably converted into a vapor before being transferred to a pipeline for transportation to specific market locations. Generally, natural gas is transported through pipeline networks as a vapor, at ambient temperature and at elevated pressure.

Liquefied natural gas is principally liquid methane, with smaller amounts of C₂⁺ hydrocarbons. It is prepared by chilling a raw natural gas stream to a temperature and at a pressure to cause at least a portion of the methane in the raw gas to condense. The natural gas stream may be recovered from any process which generates light hydrocarbon gases. Generally, the raw natural gas from which LNG is prepared is recovered from a crude oil or gas well.

LNG is generally transported at or above ambient pressure. When transported near ambient pressure, the temperature of the LNG is held at temperatures below about −160° C. (−256° F.), in order to maintain the LNG as a liquid. LNG may also be transported at pressures above ambient, with the LNG being maintained at higher temperatures than in the low pressure process. The LNG temperature is generally held at the bubble point temperature for the selected transportation pressure.

LNG which is transported to a market site is generally vaporized prior to being placed into a pipeline or otherwise transported to market, using a process termed “regasification”. During regasification, the LNG is contacted within a heat exchanger with a heat exchange fluid to vaporize at least a portion of the LNG. Air and water are desirable inexpensive heat exchange fluids. Vaporizing LNG may take place on board an LNG carrier, in an offshore LNG storage facility or at an onshore LNG storage facility. The LNG may also be warmed and/or vaporized in a refrigeration zone which provides cooling for, for example, air conditioning, and for process cooling and refrigeration in refineries and chemical plants.

LNG is normally shipped at low pressure (approximately ambient), while natural gas pipelines typically operate at high pressure (>1000 psig). There are two approaches for preparing the low pressure liquid as a high pressure vapor for distribution and sale. The more costly approach is to gasify the LNG at low pressure, and then compress the LNG vapor to high pressure. This approach is less desirable, on account of the complexity and relative cost of compressing a gaseous or vapor stream. A less costly approach is to pump the LNG to high pressure prior to regasification.

The vapor space in a tank above LNG contains a valuable LNG vapor product. Since LNG naturally vaporizes at a slow rate during transport and storage, recovering and using the LNG vapor product (otherwise known as “boil-off gas”) is important. The boil-off gas (BOG) in the LNG storage tank (either within a ship or in a fixed storage tank) presents a particular problem. Transferring the boil-off gas into the distribution pipeline requires compressing the gas to an intermediate pressure 100 psi) between the storage pressure and the distribution pressure. At the intermediate pressure, the boil-off gas is mixed with liquid LNG. The boil-off gas condenses with the LNG stream at the intermediate pressure. The combined LNG stream is then pumped through one or more additional pumping stages to increase the pressure of the LNG stream to a pipeline distribution pressure prior to vaporization.

BOG rates at an LNG terminal vary widely through typical operating cycles. While the LNG carrier is offloading to the terminal tanks, BOG rates are very high. Outside of the ship offloading period, BOG rates from the terminal tanks are very low. It is possible when a ship is present to return a significant quantity of BOG to the ship at much lower pressure than the terminal intermediate pressure by using a blower. However, a residual amount of BOG is usually compressed to the terminal intermediate pressure. LNG terminals typically install compressors large enough to compress all of the BOG to the terminal intermediate pressure even though the residual BOG rate that must be theoretically be compressed to the terminal intermediate pressure is small. While this is accepted practice in the industry, compressing the BOG vapor is expensive and can present operability and reliability challenges. A simpler or less costly method for moving the residual boil-off gas into the natural gas distribution system without mechanical compression to the terminal intermediate pressure is desirable.

US2004/0093875 is directed to a process for converting a vapor rich in methane at a first pressure to a predetermined second pressure higher than the first pressure. However, the problem with the disclosed process is that the vapor rich in methane must be at high pressure, and thus, the process cannot be used to capture residual boil-off gas at or near atmospheric pressure.

### SUMMARY OF THE INVENTION

The present invention achieves the advantage of recovering boil-off gas from LNG storage tanks at or near atmospheric pressure.

In an aspect of the invention, a process for recovering boil-off gas includes: vaporizing a liquefied natural gas from an LNG stream at a delivery pressure; recycling a portion of the vaporized natural gas to a first mixing zone; withdrawing a boil-off gas from an LNG tank to the first mixing zone; mixing the boil-off gas and vaporized natural gas stream output from the first mixing zone; combining the mixed boil-off gas and vaporized LNG with a portion of an LNG stream at an intermediate pressure; and pressurizing the liquefied natural gas having the intermediate pressure to a delivery pressure.

Preferably, the above process further includes compressing at least a portion of the boil-off gas prior to the mixing step.

More preferably, the first mixing zone includes an eductor.

### DESCRIPTION OF THE DRAWINGS

FIG. 1 illustrates an embodiment of the invention, showing a process for recovering boil-off gas.

### DETAILED DESCRIPTION OF THE INVENTION

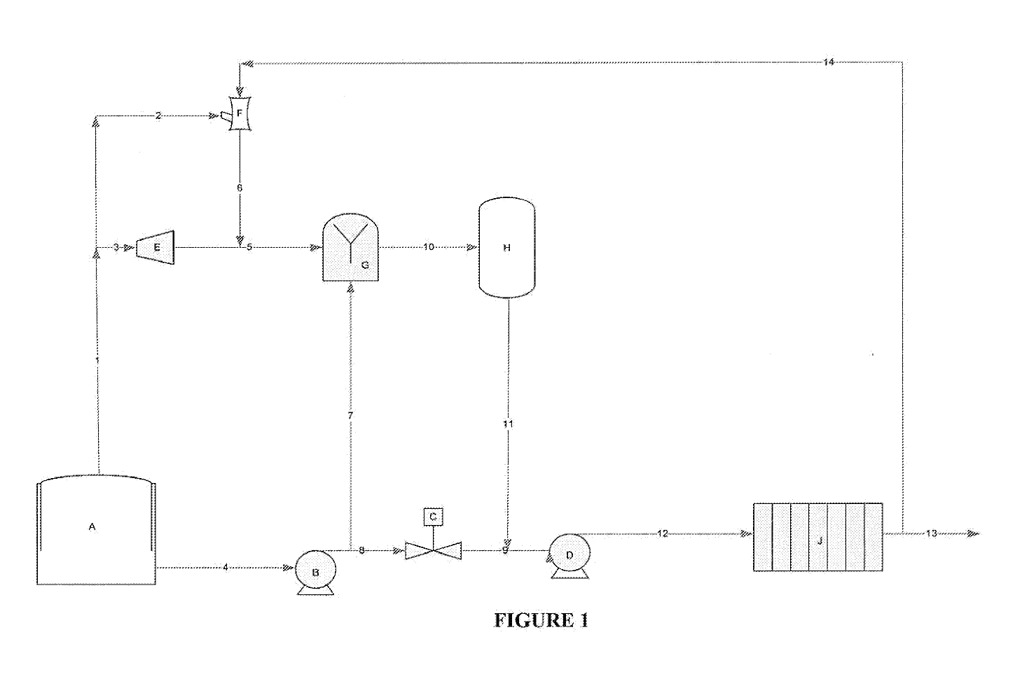

In the embodiment of the invention illustrated in FIG. 1, a liquefied natural gas is maintained at a select pressure in container (A). Generally, the container is designed for a particular pressure, and the temperature of the LNG equilibrates to the bubble point temperature at the select pressure. However, it will be readily understood that storing LNG at a temperature below that of the bubble point is well within the range of current technology, and that the present process encompasses the full range of LNG storage temperatures. The design of the container in which LNG is stored is not crucial to the invention, and includes stationary storage located either on-shore or off-shore in an aquatic location. Alternatively, the LNG may be stored in a mobile container, located, for example, in a ship or on a truck, barge, train or the like.

The present process can be employed with LNG stored over the full range of possible storage pressures, including pressure from ambient pressure to pressure of 1500 psig and above. In one embodiment, the LNG is stored at a pressure of about 75 psig or less. In a separate embodiment, the LNG is stored at approximately ambient pressure. In actual practice, it is preferred to maintain the LNG at a storage pressure slightly above ambient pressure (e.g. 100-200 mbar gauge) to ensure acceptable pressure control.

During the process of the present invention, LNG at storage pressure is passed from container (A) to a 1^{st} pressurization step (B) for increasing the pressure of the LNG to an intermediate pressure in (8). In the broad embodiment, intermediate pressure at (8) is in the range of between the storage pressure of container (A) and the pipeline delivery pressure at (13). In the embodiment illustrated in FIG. 1, the intermediate pressure is between 25 and 500 psig. A pressure range of 50 to 250 psig is illustrative. A pressure in the region of 100 psig is a specific example of the process.

The intermediate pressure LNG at (8) is passed through a control valve (C) to produce stream (9) and then to a 2^{nd} pressurization step (D) for increasing the LNG pressure to a vaporization pressure at (12). Generally, the vaporization pressure will be set by the pipeline delivery pressure at (13), increased by some relatively small pressure differential to account to pressure losses across the vaporizer (J). The pressurized LNG at (12) is then passed across the vaporizer (J), for converting at least a portion of the LNG to vaporized LNG (13). Illustrative vaporizers include shell and tube heat exchangers, open rack vaporizers and the like. The vaporized LNG (13) is at pipeline delivery pressure, and available for sending to a pipeline delivery system or to another customer of natural gas. Generally the pipeline delivery pressure to which the natural gas is compressed is greater than 1000 psig. A pressure in the region of 1300 is illustrative.

For purposes of this application, the term “vaporized LNG” represents vapor phase natural gas which originated as liquefied natural gas. It will be recognized that vaporized LNG will be predominately in the vapor phase, but may contain small amounts of liquefied components.

The present invention is directed, at least in part, to a method for recovering BOG which is generated during LNG storage and handling, prior to the LNG vaporization process. Since LNG is maintained at a temperature below, and generally well below, ambient temperature, a small amount of LNG will vaporize during storage and handling as heat is absorbed through container walls. To protect against an over-pressure condition in the LNG container as the LNG vaporizes, the vaporized BOG is generally sent to a flare. On account of its value as an energy source, and the environmental penalty if the BOG is vented to the atmosphere, it is desirable to recover and reprocess the vented BOG.

Conventional process to recapture BOG generated during LNG storage and handling involves blending the BOG into the pipeline gas which is the product of vaporized LNG. Conventionally, this involves compressing the BOG as a vapor to pipeline delivery pressure. In a second conventional approach, the BOG at storage pressure is compressed with sufficient cooling to convert the BOG to an intermediate pressure LNG. The intermediate pressure LNG in this process may then be pressurized to pipeline distribution pressure, vaporized and passed to the natural gas distribution system. Both of these approaches require the compression of vaporized gas to high pressures. Vapor-phase compression is expensive, a less expensive alternate is desired.

In the embodiment illustrated in FIG. 1, BOG is recovered from LNG storage (A) and is passed to mixing zone (F). Many types of mixing zones can be contemplated for this step. A preferred mixer is an eductor (otherwise known as an ejector) which uses the motive force of a high velocity fluid to draw a second lower pressure fluid into the mixing zone and to mix the two fluids at a pressure which is intermediate between that of the high velocity fluid entering the mixing zone and the low pressure fluid entering the mixing zone.

In the present invention, the low pressure fluid is the BOG (2) originating from LNG storage or handling. The high velocity fluid is a vaporized LNG (14) which is recovered from the vaporized LNG (13) at pipeline distribution pressure. In effect, the high pressure vaporized LNG (14) provides the motive force within the 1^{st} mixing zone (F) for withdrawing BOG (2) from LNG storage (A). During the mixing process, the pressure of the vaporized LNG (14) is reduced to the extent that at least a portion of the blend of vaporized LNG and BOG is condensed to a liquid phase LNG (6). The mixture (6) is optionally combined with additional LNG (7) at intermediate pressure and passed to a 2^{nd} mixing zone (G) for completing the condensation process. An illustrative example of a 2^{nd} mixing zone (G) is a static in-line mixer. Such mixers are well known in the art, and do not require additional description. The mixture is then passed to a settling vessel (H) and then returned to the intermediate pressure LNG stream (9) in preparation for additional pressurization and then vaporization.

During certain periods, an unusually large quantity of BOG may be generated during the LNG vaporization process. An illustrative example is filling the LNG tank from an external source such as a ship. Under these conditions, it may be desirable to operate a separate compressor (E) to pass at least a portion of the BOG (3) at an intermediate pressure at (5), in combination with LNG (7), to 2^{nd} mixing zone (G) for condensing the BOG, passing the mixture to settling vessel (H) and then combining the product with intermediate pressure LNG (9).

What is claimed is:

1) A process for recovering boil-off gas, comprising:
(a) vaporizing a liquefied natural gas from an LNG stream at a delivery pressure;
(b) recycling a portion of the vaporized natural gas to a first mixing zone;
(c) withdrawing a boil-off gas from an LNG tank to the first mixing zone;
(d) mixing the boil-off gas and the vaporized natural gas stream output from the first mixing zone;
(e) combining the mixed boil-off gas and vaporized LNG with a portion of an LNG stream at an intermediate pressure; and
(f) pressurizing the liquefied natural gas having the intermediate pressure to the delivery pressure.

2) The process for recovering boil-off gas according to claim 1, further comprising:
(a) compressing at least a portion of the boil-off gas prior to the mixing step.

3) The process for recovering residual boil-off gas according to claims 1 or 2, wherein the first mixing zone comprises an eductor.
